(19) United States
(12) Patent Application Publication
(10) Pub. No.: US 2024/0394874 A1
(43) Pub. Date: Nov. 28, 2024

(54) METHOD AND SYSTEM FOR RETINAL TOMOGRAPHY IMAGE QUALITY CONTROL

(71) Applicants: NOCTURNE GMBH, Berlin (DE); CHARITÉ-UNIVERSITÄTSMEDIZIN BERLIN, Berlin (DE); THE REGENTS OF THE UNIVERSITY OF CALIFORNIA, Oakland, CA (US)

(72) Inventors: Alexander BRANDT, Ladera Ranch, CA (US); Josef KAUER-BONIN, Berlin (DE); Ella Maria KADAS, Berlin (DE); Sunil Kumar YADAV, Berlin (DE)

(73) Assignees: NOCTURNE GMBH, Berlin (DE); CHARITÉ-UNIVERSITÄTSMEDIZIN BERLIN, Berlin (DE); THE REGENTS OF THE UNIVERSITY OF CALIFORNIA, Oakland, CA (US)

(21) Appl. No.: 18/690,770

(22) PCT Filed: Sep. 8, 2022
(86) PCT No.: PCT/EP2022/075042

§ 371 Date: Mar. 11, 2024

Related U.S. Application Data
(60) Provisional application No. 63/242,081, filed on Sep. 9, 2021.

(51) Int. Cl. G06T 7/00

(52) U.S. Cl. CPC G06T 7/0012; G06T 2207/10101; G06T 2207/20081; G06T 2207/20084; G06T 2207/30041

(57) ABSTRACT

Retinal optical coherence tomography (OCT) with intraretinal layer segmentation is increasingly used not only in ophthalmology but also for neurological diseases such as multiple sclerosis (MS). Signal quality influences segmentation results, and high-quality OCT images are needed for accurate segmentation and quantification of subtle intraretinal layer changes. Among others, OCT image quality depends on the ability to focus, patient compliance and operator skills. Current criteria, for OCT quality define acceptable image quality, but depend on manual rating by experienced graders and are time consuming and subjective. In this paper, we propose and validate a standardized, grader-independent, real-time feedback system for automatic quality assessment of retinal OCT images. We defined image quality criteria for scan centering, signal quality and image completeness based on published quality criteria and typical artifacts identified by experienced graders when inspecting OCT images. We then trained modular neural networks on OCT data with manual quality grading to analyze image quality features. Quality analysis by a combination of these trained networks generates a comprehensive quality report containing quantitative results. We validated the approach against quality assessment according to the OSCAR-IB criteria, by an experienced grader. Here, 100 OCT files with volume, circular and radial scans, centered on optic nerve head and macula, were analyzed and classified. A specificity of 0.96, a sensitivity of 0.97 and an accuracy of 0.97 as well as a Matthews correlation coefficient of 0.93 indicate a high rate of correct classification. Our method shows promising results in comparison to manual OCT grading and may be useful for realtime image quality analysis or analysis of large data sets, supporting standardized application of image quality criteria.

### 2 TECHNICAL FIELD

Retinal imaging, Optical coherence tomography, Image analysis, Machine learning Medicine, Neurology, Ophthalmology

### 3 BACKGROUND

The application of retinal optical coherence tomography (OCT) in neurology and ophthalmology has widened significantly in recent years. Next to OCT's now ubiquitous role in the diagnosis of primary eye disorders, it allows for the non-invasive, in vivo imaging of neuronal and axonal retinal structures, which allows its output to be used as biomarkers for neurological disorders like multiple sclerosis (MS) [Brandt et al., 2017], neuromyelitis optica spectrum disorders (NMOSD) [Motamedi et al., 2020], myelin oligodendrocyte glycoprotein antibody mediated disease [Pache et al., 2016], Parkinson's disease [Veys et al., 2019] or Alzheimer's disease [Cabrera DeBuc et al., 2019], diseases typically associated with optic nerve or retinal pathologies. Modern spectral domain OCT devices are precise and reliable instruments, able to quantify distinct retinal changes, e.g. retinal layer thinning in the range of a few micrometers, which is often within the range of subtle changes in these disorders [Motamedi et al., 2019]. For example, the annual retinal nerve fiber layer (RNFL) loss in patients with MS is typically below 1 m, which is in the range of current OCT segmentation performance [Balk et al., 2016].

OCT image quality is paramount to allow accurate segmentation of individual intraretinal layers, especially in cases where small changes need to be detected. Layer segmentation results are influenced by signal quality, and differences in signal quality between measurements may bias results [Wu et al., 2009]. Indeed, the widely used APOSTEL recommendations for reporting quantitative OCT studies explicitly require systematic quality control when using October outcomes in clinical studies [Aytulun et al., 2021]. Several studies proposed quality scores to quantify OCT image quality or suitability for segmentation [Stein et al., 2006, Lee et al., 2016, Liu et al., 2009, Huang et al., 2012]. The development of the OSCAR-IB criteria have been a major achievement towards the definition of standard procedures for quality assessment of OCT images [Tewarie et al., 2012]. The OSCAR-IB criteria rate quality of OCT images based on expert grader assessment of several quality indicators: (O) obvious problems, (S) poor signal strength, (C) centration of scan, (A) algorithm failure, (R) unrelated retinal pathology, (I) illumination and (B) beam placement. Importantly, OSCAR-IB rating is based on a manual evaluation, which is not only time consuming but also requires considerable domain knowledge and remains subjective. Consequently, inter-rater agreement is mediocre [Schippling et al., 2015], which has to be considered when collecting OCT for clinical research.

Here we propose a method for fully automatic quality analysis of retinal OCT images (AQUA-OCT). As main contribution, our method detects several key image quality aspects inspired by the OSCAR-IB criteria, and the output is produced through the interaction of different deep convolutional neural networks (DCNN). Being fully automated, the method is grader-independent, fast, and allows real-time quality control of OCT images. A modular design allows future extension by adding additional or replacing existing quality criteria. We train the method on OCT images from our OCT reading center and validate it against human-labeled reference data from our center based on OSCAR-IB quality assessment.

### 4 SUMMARY

In this paper, we present an approach towards a fully standardized, grader-independent and feasible real-time method to evaluate image quality in retinal OCT. Our proposed automatic quality analysis (AQUA-OCT) is capable of analyzing single OCT scans up to complete large data sets in a 3-stage process (data review, data analysis and user feedback). This work was focused on the applicability of such a system in a real-life clinical setting, where specialized computation hardware is scarce and OCT scan acquisition is done using multiple devices and scan modalities.

### 4.1 Model Training and Pipeline Performance

Three independent DCNNs for classification (Reg-Net, AQUA-Net) and semantic segmentation (Cent-Net) were carefully designed and trained to provide optimal performance with lowest needs of computational consumption. All network models were trained with data from our extensive clinical OCT data base acquired with both Spectralis SD-OCT by Heidelberg Engineering and Cirrus HD-OCT by Carl Zeiss Meditec. A successful transfer learning of our Spectralis pre-trained AQUA-Net to Cirrus data proofed the capability to extend the application to different OCT data using this procedure. To ensure the analysis is adaptable to various needs in clinical settings we trained the system with diverse scan types, e.g. volume scans, circular scans and radial scans centered on either the ONH or the macula. Furthermore, configurable analysis criteria and ROIs enable a high degree of freedom to perform quality analysis dependent on the specific analysis needs. A final quality report contains the complete numerical results of the analysis as well as Boolean flags of our three quality features centering, signal quality and image completeness. In addition, quality maps depicting the fundus image with a color-coded error map overlay provides a fast visual feedback to the user.

We validated each network on its respective test data set, after monitoring the validation accuracy to reach convergence. Our models reached a test accuracy of accReg-Net-1.0, accCent Net-0.9941 and acc AQUA-Net-0.9688 with computing times of 0.013 s for the smallest model up to 0.301 s for the largest model for a single image input on CPU. Comparing our systems ability to identify the center of the focused retinal region against manually labeled gold standard we achieved an average deviation of 0.36 B-scans and 2.45 A-scans to correctly identify the fovea centralis. Furthermore, to correctly identify the center of the ONH we achieved an average error of 2.45 pixel for Spectralis and 1.57 pixel for Cirrus on the original network input image of size 200×200 pixels. With an average ONH diameter of 40 pixel for Spectralis and 60 pixel for Cirrus, this deviation becomes negligibly small in correctly placing the ROI onto the ONH.

We achieved an overall accuracy of acc=0.97 with a sensitivity of sens=0.9722 and a specificity of spec=0.9643, yielding high classification capabilities to correctly identify insufficient scans. A AQUA-OCT-grader discrepancy of 3% which is within the rater-rater discrepancy of 10% in the original work by Tewarie et al. and a Cohen's kappa of K-0.926 our AQUA-OCT-grader agreement can compete with the OSCAR-IB validation done by Schippling et al., where they achieved a strong inter-rater agreement of K-0.7.

4.2 Comparison with State-of-the-Art

Work done by Zhang et al., Wang et al. and Wang et al. demonstrated the capability of state-of-the-art ImageNet pre-trained ResNet50 to classify retinal OCT Bscans according to their respective quality classes. Running large networks like ResNet50 (about 23 million parameters) relies on hardware with sufficient memory and computation capabilities that cannot be expected in clinical settings outside of specialized research centres. We designed specific modular DCNNs that contain the capacity (all models i 180k parameters) to predict with high accuracy with minimal computation cost and due to their sizes are less prone to overfitting. Table 1 shows the comparison of the computation time on CPU and GPU averaged over 128 images for a single B-scan between the convolutional bases of VGG16, VGG19 and ResNet50 and our AQUA-Net for input dimensions of 496×512 pixels. This result shows the increased computation time efficiency using our problem-oriented design versus the state-of-the-art classification models.

TABLE 1
The table shows model size and computation time for a single
B-scan on CPU and GPU of the convolutional bases for well-
known architectures of VGG16, VGG19 and ResNet50 compared
to AQUA-Net. The input dimension for all models were changed
to 496 × 512 pixels to match the AQUA-Net input.

| | VGG16 | VGG19 | ResNet50 | AQUA-Net |
|---|---|---|---|---|
| CPU time [s] | 1.716 | 2.286 | 0.625 | 0.202 |
| GPU time [s] | 0.336 | 0.512 | 0.191 | 0.059 |
| Number of parameters | 14.7M | 20M | 24M | 109k |

Applying domain shift via transfer learning from ImageNet database to OCT data requires a representative data set of sufficient size to reflect possible OCT quality, what is not fulfilled in previous work. This might lead to fast training overfitting and a low performance on new data. The use of ImageNet pre-trained models requires 3-color RGB images with dimensions of 224×224. Downscaling OCT scans from e.g. 768 or 1536 A-scans to 224 A-scans can potentially cause important image features to disappear. Also, using a convolutional base trained to process RGB images is not optimal for medical one channel gray value images. In order to adapt our DCNNs optimally to the OCT image domain we accessed our excessive database containing OCT scans with a huge variability of image quality.

While previous work introduced new pipeline architectures utilizing ImageNet pre-trained ResNet50 yielding promising accuracy results, they did not add more functionality to the actual quality analysis. Instead of a B-scan wise classification we designed our system to obtain a quality classification with A-scan resolution providing a quality map for fast result visualization. We added inter-device (Spectralis and Cirrus OCT) and multiple scan types capability (volume, radial and circular) as well as multiple regions (ONH and macula) to be processed by our pipeline. The addition to verifying the retinal region as well as determining the center of the region together with the image quality analysis provides a sophisticated tool able to assist in a variety of clinical settings.

Despite being based on the OSCAR-IB criteria our system does not reflect these criteria as its quality features in the result. Most criteria are summarized in our quality features with some exceptions. Our systems does not analyze the illumination of the fundus image separately as well as the curvature of circular scans to validate the OCT beam placement.

### 4.3 Limitations, Application and Outlook

Our method in its current implementation has several limitations. First, the system has been trained on data from two device types, only, and using only scans of macula and optic nerve head. Different devices and additional scan types using e.g. wide field optics or OCT angiography could be implemented in the future by adding respective training data. Considering the OSCAR-IB criteria, our method does not assess criterion R (retinal pathology) and B (beam placement). In our experience, the retinal pathology criterion requires careful consideration of the OCT measurements purpose in a clinical and research context. Currently, this needs to be assessed by a human expert grader, otherwise there may a be a risk of missing relevant findings by unnecessarily excluding scans. Thus, this criterion does not constitute a typical quality aspect, but should be considered separately after quality analysis. Potentially, this process could be supported by artificial intelligence systems trained on OCT scans with multiple retinal pathologies [De Fauw et al., 2018]. Highly relevant is here the origin of the training data, which currently contains images of patients with neurological or optic nerve conditions, but lacks images with primary retinal pathologies. Applications in primary eye disorders require further training on relevant data. Beam placement has been shown to be potentially relevant for peripapillary ring scans as it may alter tissue transsection and thus thickness measurements [Balk et al., 2012]. While it is technically feasible to train a network to detect beam placement, in our experience this criterion is rarely—if ever —relevant for accepting or rejecting the quality of a scan and may be better controlled by appropriate data acquisition [Aytulun et al., 2021].

Currently, we apply the method routinely in our reading center to support manual grading in studies utilizing OCT in neurologic disorders. In our experience, AQUA-OCT results are highly consistent with quality expert grading results, and we are currently investigating and validating this application in a follow-up study. Most preferably, our method could give feedback on OCT quality when it matters most-when the possibility of re-scanning a subject still exists. i.e. in real time when the subject is still at the scanner. This could be achieved by. e.g., implementing the method directly on the device, or as a web or cloud service, to which an operator immediately uploads the scans after acquisition. Currently, OCT quality analysis is not performed in real time and especially in the context of clinical studies where an independent expert quality grading is highly recommended, this may lead to unnecessarily missing data [Aytulun et al., 2021].

### 4.4 State of the Art

In previous works, we obtained first promising results in determining image quality column wise in OCT B-scans using the high generalization ability of a DCNN classifier [Kauer et al., 2019]. We trained the DCNN to classify image columns into sufficient or insufficient signal and upper or lower clipping. Furthermore, we demonstrated the network's ability to predict quality on previously unseen data from an OCT device of a different manufacturer.

Recent work by Zhang et al. utilized a pre-trained ResNet50 from the ImageNet Large Scale Visual Recognition Challenge (ILSVRC) as a feature extractor and combined it with support vector regression to primarily address OCT signal intensity. They revised and fine-tuned the network using a data set of 482 OCT images, which were previously quality scored by clinical experts.

Wang et al. also utilized a pre-trained ILSVRC-ResNet50 to classify OCT quality based on signal completeness, location and effectiveness into the four categories ‘good’, ‘off-center’, ‘signal-shielded’ and ‘other’. While still needing prior manual data screening to remove outlier data, e.g. images with complete signal obstruction, they demonstrated the usefulness of such image quality assessment (IQA) with high accuracy on retinopathy detection, where accuracy was higher with the data set that passed OCT-IQA.

From a different group. Wang et al. proposed a deep and shallow features fusion network (DSFF-Net) that likewise utilizes the ILSVRC-ResNet50 as the pipeline backbone to grade OCT images into ‘good’, ‘usable’ and ‘poor’. They used two parallel streams to extract separately deep abstract and shallow features, and combined them into a single output classification to obtain high accuracy on classifying image quality.

Utilizing a well-established image classification network like ResNet50 yielding high accuracy in detecting quality issues or pathological abnormalities in these previous studies comes with a high computation cost and memory re-quirement. Running an IQA pipeline with the ImageNet pre-trained ResNet50, yielding over 23 million parameters, requires more than the average consumer grade hardware to utilize GPU acceleration. Furthermore, due to the use of 3-color RGB images, performance of pre-trained networks is not optimally adapted to the domain of OCT images with one channel gray value images. Our main contribution lies in the design of specific modular DCNNs that contain the capacity and level of abstraction to predict with high accuracy while minimizing the number of parameters in order to reduce computation cost to a minimum. In comparison to previous works, we further optimize our method by utilizing multi-modal OCT images, e.g. multiple regions, multiple scan types such as volume, radial and circular scans as well as OCT data from different device manufacturers. Furthermore, we extend the analysis from pure image quality to scan centering and retinal region checks. In addition, we rate B-scan regions according to our quality labels instead of one single label per image in order to provide detailed user feedback and allow application-specific image usage decisions.

### 5 BRIEF DESCRIPTION OF DRAWINGS

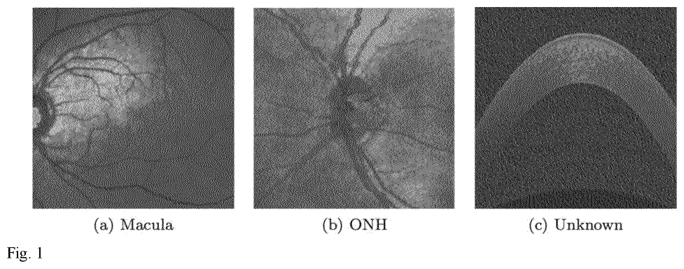

5.1 FIG. 001

Example scanning laser ophthalmoscope images of different regions. (a) macula, (b) optic nerve head (ONH) and (c) unknown (B-scan of cornea)

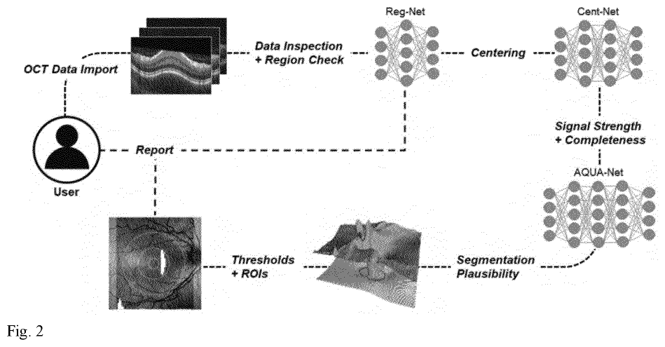

5.2 FIG. 002

Workflow of the automatic quality analysis.

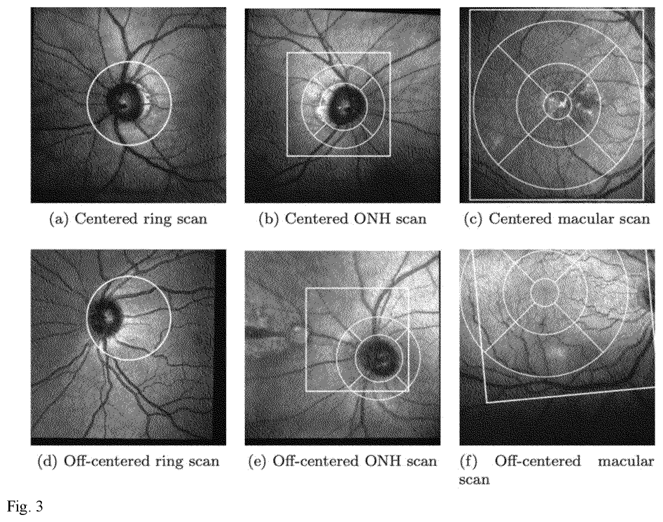

5.3 FIG. 003

Example scanning laser ophthalmoscope images with marked with scanned area (rectangles) and region-of-interest (circles). (a-c) good centering of circular optic nerve head (ONH) scan, volume ONH scan and volume macula scan. (d-f) failed centering of circular ONH scan, volume ONH scan and volume macula scan.

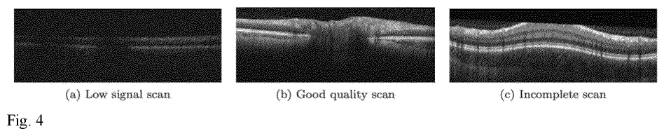

5.4 FIG. 004

Example B-scans with different quality levels. a) low signal strength areas that prohibits intra-retinal segmentation. b) good quality B-scan of the optic nerve head. c) incompleteness at the upper image border due to wrong focus depth.

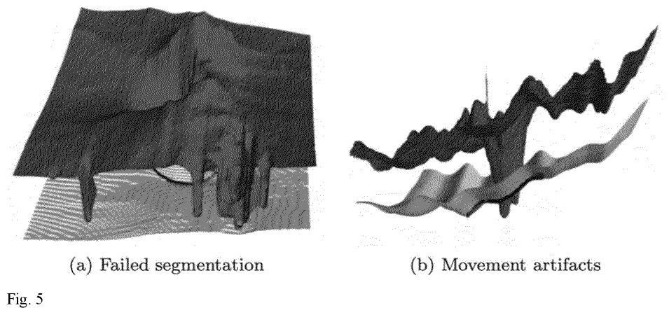

5.5 FIG. 005

a) Partially failed segmentation due to weak signal strength. b) Segmentation with visible ripples due to movement artifacts.

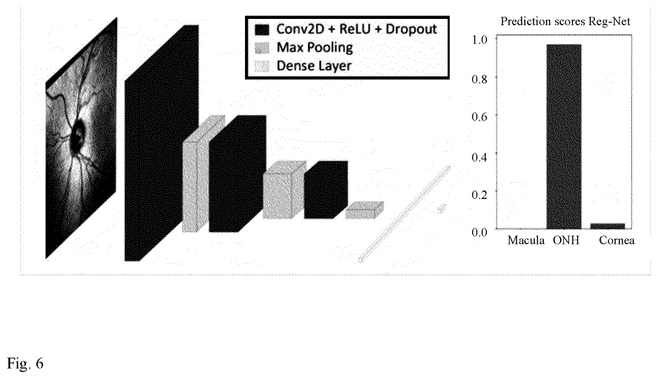

5.6 FIG. 006

Reg-Net architecture. A 200×200 pixel image forms the input and the output is a three classes prediction through multiple stages of convolutions, pooling and ReLU operations.

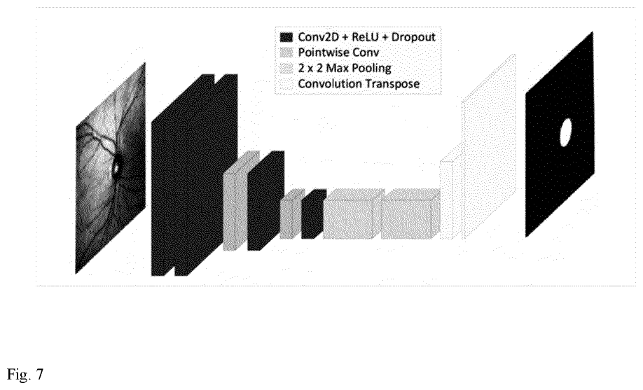

5.7 FIG. 007

Cent-Net architecture. A 200×200 pixel image forms the input and the output is a dense pixel-wise prediction map.

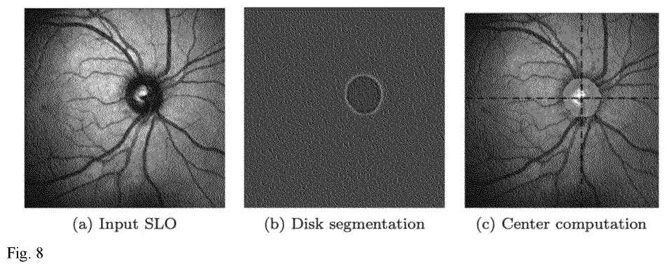

5.8 FIG. 008

Optic nerve head (ONH) center estimation based on semantic segmentation with our Cent-Net. (a) gray scale scanning laser ophthalmoscope fundus input image. (b) the output of the network is a pixel-wise prediction map differentiating between ONH and background. (c) overlaid and binarized prediction map with its geometric center of gravity representing the ONH center estimation.

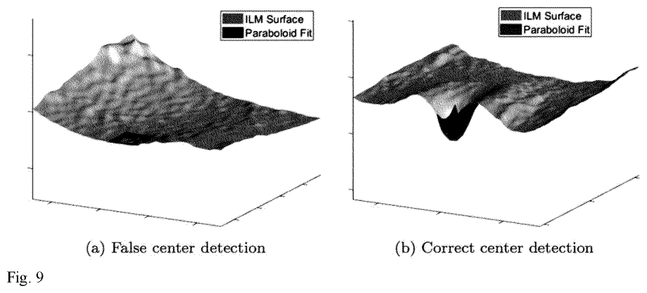

5.9 FIG. 009

(a) False center detection visible by a flat paraboloidal fit (red). (b) Correct center detection with a well fitted paraboloid (red) onto the inner limiting membrane (gray).

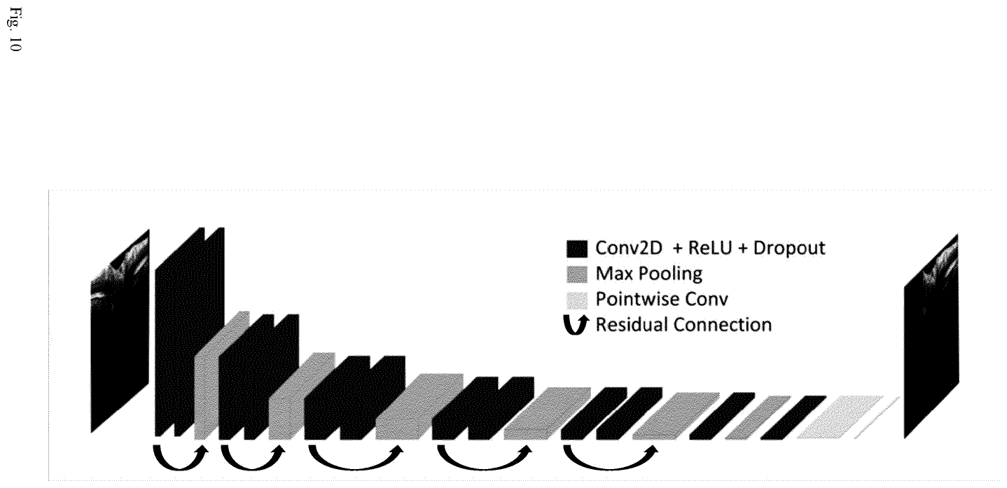

5.10 FIG. 010

AQUA-Net architecture. A 496×512 pixel image forms the input and the output is a four classes prediction of the quality features for each image column.

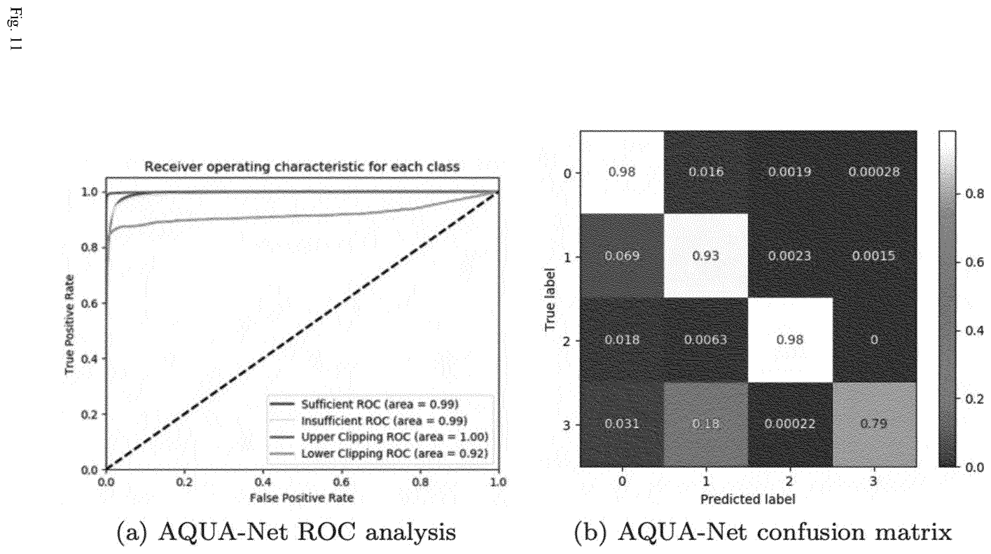

5.11 FIG. 011

(a) Receiver operating characteristic analysis for each class label of AQUA-Net performance on test data. (b) Confusion matrix of the AQUA-Net test data output with label 0-sufficient, label 1-insufficient, label 2=upper clipping and label 3=lower clipping.

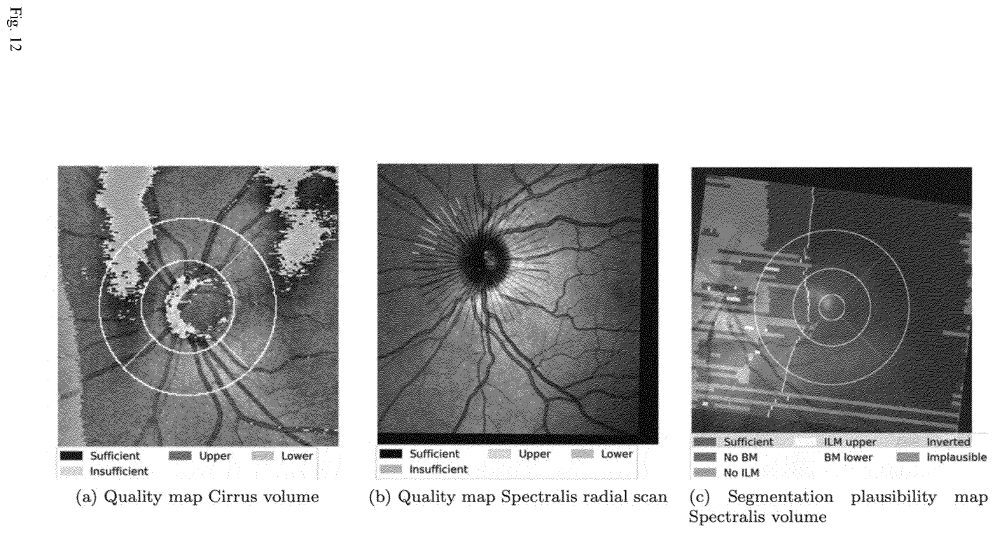

5.12 FIG. 012

Color-coded image quality maps of (a) Cirrus volume scan, (b) Spectralis radial scan and (c) segmentation quality map of a Spectralis volume scan.

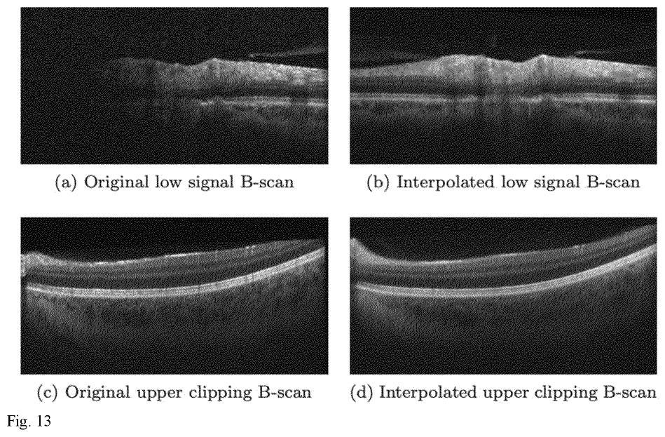

5.13 FIG. 013

B-scan example showing the effectiveness of the interpolation method. Images (a) and (c) depicting the original B-scans with the quality issues low signal due to shadowing and upper clipping with the retinal image protruding outside the upper image border. Images (b) and (d) showing their respective interpolated counterparts.

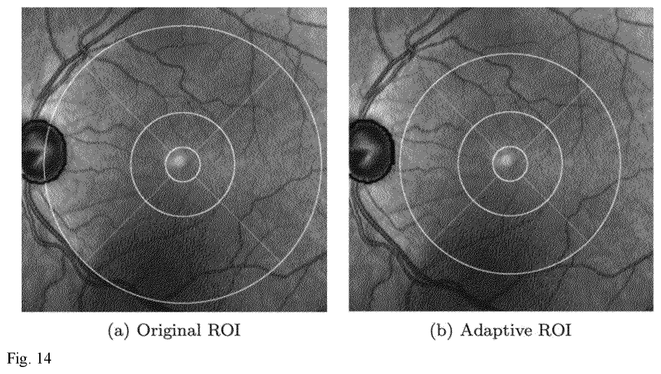

5.14 FIG. 014

Example SLO images depicting the effect of adaptive ROI. (a) ROI with its outer ring overlapping the optic disc (red line). (b) Adaptive ROI preventing the overlapping of the ROI and the opic disc.

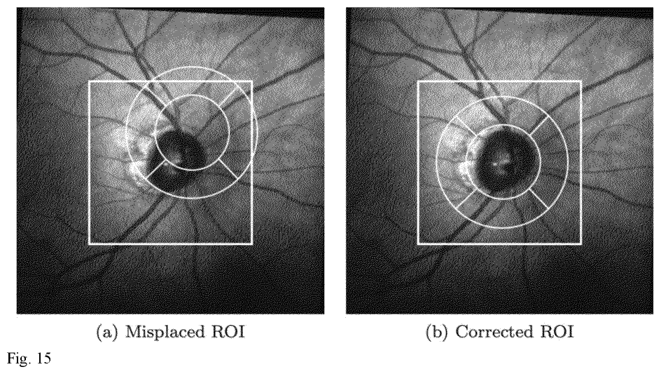

5.15 FIG. 015

Example SLO images depicting the effect of re-centering. (a) A misplaced ROI missing data equidistant around the optic disc. (b) The re-centered ROI covering all the data around the optic disc.

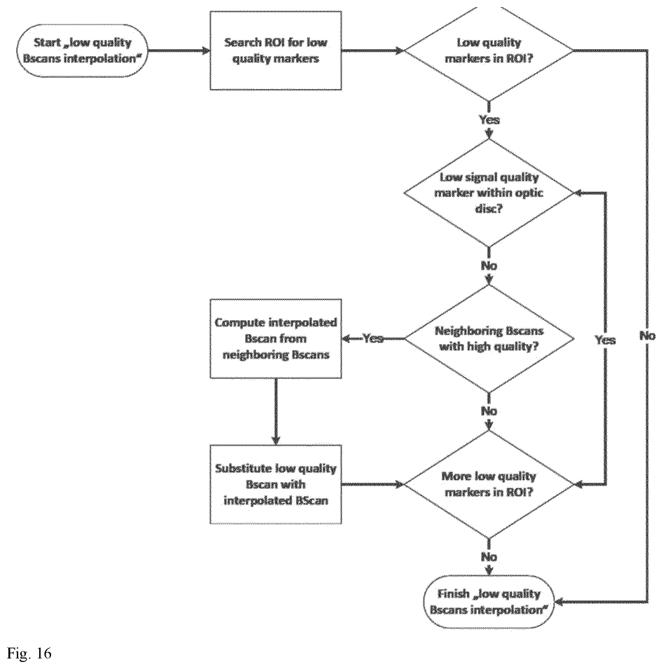

5.16 FIG. 016

Workflow of the quality controlling “low quality Bscans interpolation”.

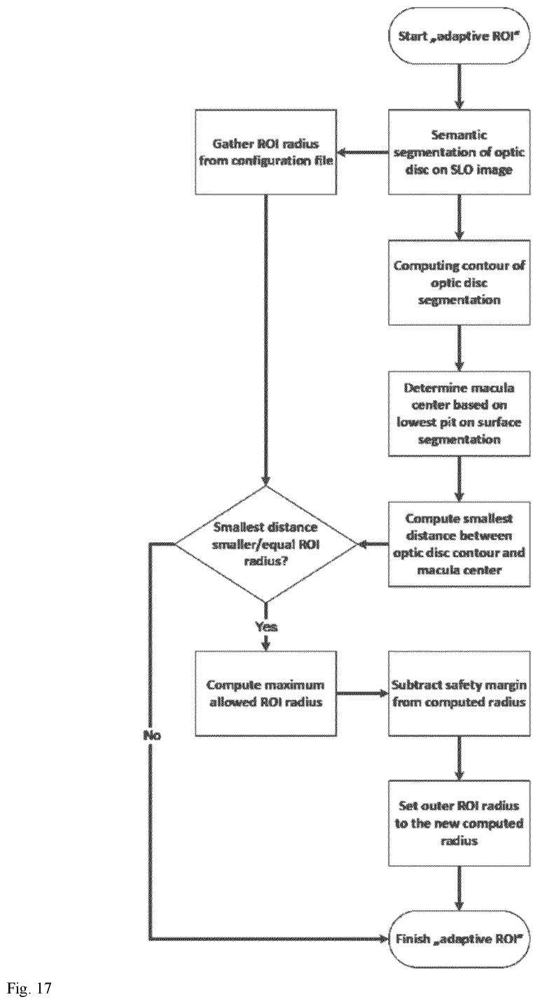

5.17 FIG. 017

Workflow of the quality controlling “adaptive ROI”.

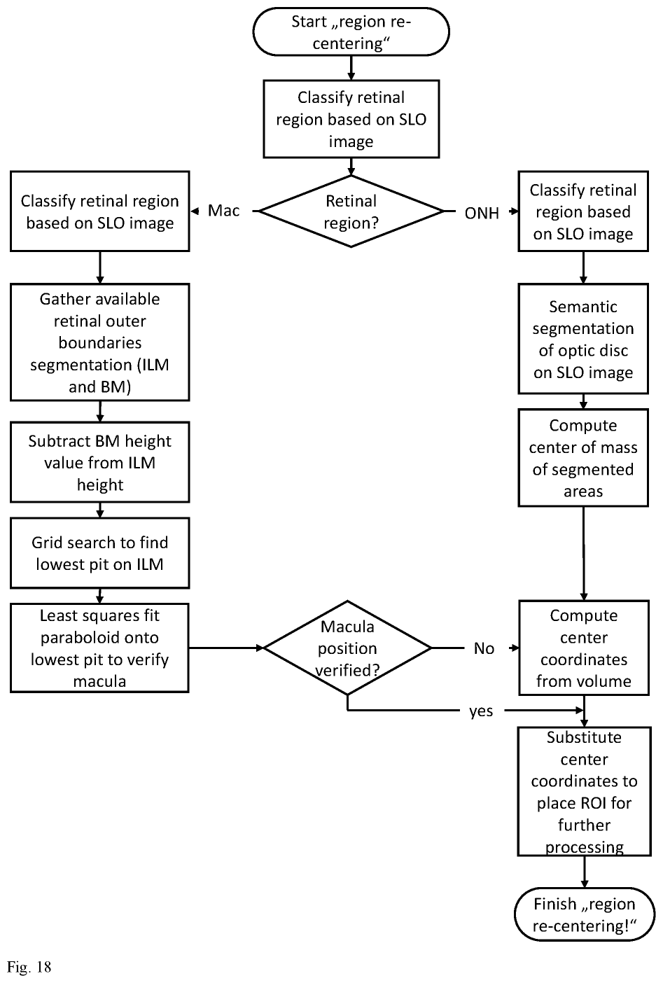

5.18 FIG. 018

Workflow of the quality controlling “region re-centering”.

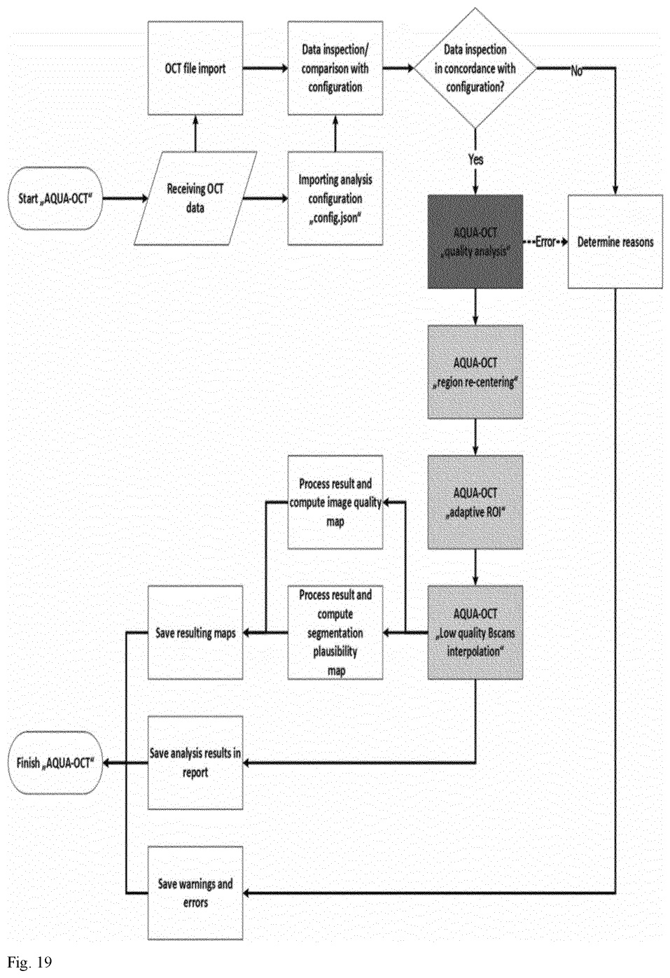

5.19 FIG. 019

Workflow of the quality analysis with AQUA-OCT with additional quality controlling steps “region re-centering”, “adaptive ROI” and “low quality Bscans interpolation”.

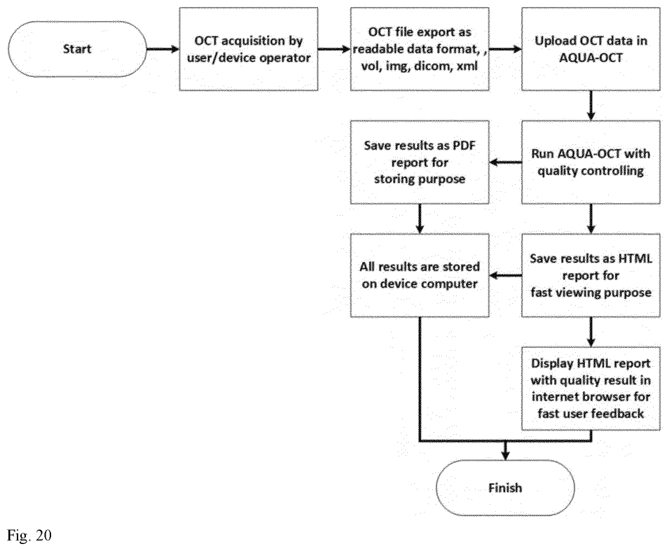

5.20 FIG. 020

Workflow of the quality analysis with AQUA-OCT with additional quality controlling running on OCT device directly.

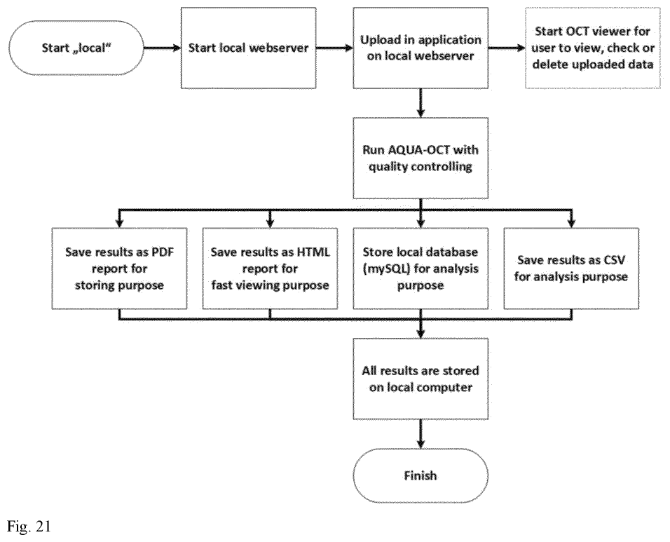

5.21 FIG. 021

Workflow of the quality analysis with AQUA-OCT with additional quality controlling running on a local web server on a separate machine.

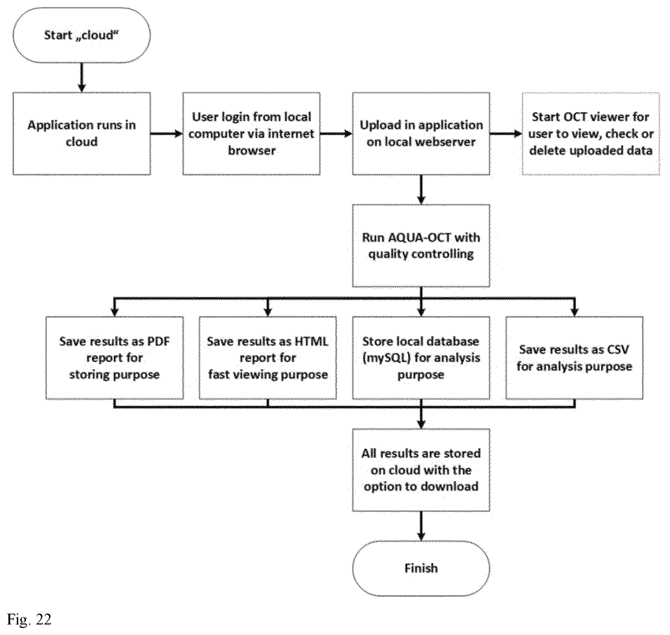

5.22 FIG. 022

Workflow of the quality analysis with AQUA-OCT with additional quality controlling running on a cloud-based remote connection.

### 6 DESCRIPTION OF EMBODIMENTS

### 6.1 Image Quality Analysis

AQUA-OCT has been developed as an automatic support system for analyzing retinal OCT quality. The quality analysis does not simply accept or reject scans, but provides detailed quality criteria, which then allow informed decisions as to whether the scans can be used for a specific purpose or not. Users can define different analysis procedures, quality features, thresholds and ROIs regarding their data, e.g. circular- or volume-scans in a configuration file. The typical workflow of AQUA is illustrated in FIG. 2. OCT analysis begins with OCT data import. A automatic data inspection then verifies a matching assignment of the OCT scan with constraints in the configuration file, including e.g. retinal region, scan type and dimensions.

Next, quality features are determined using a sequence of 3 specialized DCNNs further described below, focusing on region check, centering and signal strength and completeness. A fourth quality feature, segmentation plausibility, is detected using traditional image analysis methods. After quality analysis, configured thresholds and ROIs are applied. After completed analysis, all quality features are visualized in a report. Here, quality analysis results are provided as a color-coded overlay atop the OCT accompanying scanning laser ophthalmoscopy (SLO) image. Detailed quality analysis results are available as spread sheet.

### 6.1.1 Definition of Quality Features

Region We defined region as the landmark with the primary focus in SLO fundus images. In a given SLO image, the region is macula when the fovea centralis and its surrounding blood vessels are clearly visible, whereby the optic nerve head (ONH) can be partially- or non-visible as shown in FIG. 1 (a). Similarly, the region is ONH (in volume, radial, and circular scans) when the ONH is entirely visible, whereby the macula can be partially or non-visible (FIG. 1 (b)). Additionally, the unknown region is defined if the image does not contain macula or ONH (FIG. 1 (c)). The unknown region was added as safety mechanism to avoid the accidental use of the pipelines for other types of data than retinal SLO fundus images. FIG. 1 shows exemplary images of each region type.

Centering Correct centering is indispensable in obtaining reliable OCT data. For example, a de-centered peripapillary circular scan fails to obtain data equidistant from the ONH center (FIG. 3d), which is important to correctly determine the thickness change of the retinal nerve fiber layer (RNFL) around the ONH when evaluating the progress in MS and other diseases [Petzold et al., 2010].

We defined the center of the macula as the deepest point of the foveal pit, containing a central light reflex [Yadav et al., 2017] visible in the B-scans. The ONH center is defined as the geometric center of gravity of the Bruch's membrane opening (BMO) marked in the B-scan [Yadav et al., 2018].

In the case of circular, volume and radial scans, a good centering is defined by a small deviation, set in the configuration by the user, of the center of the ONH or macula to the scan center of the device (FIG. 3 (a) in comparison to failed centering FIG. 3 (d)). Furthermore, a good centering is defined when the scanned area completely encloses the ROI set by the user (FIG. 3 (b) in comparison to failed centering FIG. 3 (e)). Also, an ROI entirely inside the FOV (within SLO image) of the device (FIG. 3 (c) in comparison to failed centering FIG. 3 (f)).

Completeness and Signal Strength Incomplete scans miss important data, e.g. retinal tissue outside the field of view (FOV), and can prevent correct layer segmentation (FIG. 4). A failed image registration. pathological reasons or a misplaced focus point might shift the image outside upper or lower image borders. A low signal-to-noise-ratio (SNR) or low contrast is the result of insufficient focusing or beam alignment. patient movement or pathological disorders such as cataract, floaters in the vitreous body or burst blood vessels (FIG. 4).

We defined completeness as no retinal tissue being outside the FOV of the device nor outside the upper or lower image borders in each single A-scan (FIG. 4 (b) compared to incomplete data in FIG. 4 (c)). In accordance with an expert grader (HZ), good signal strength was defined by clearly distinguishable outer retinal boundaries (ILM and BM) from the image background and recognizable inner retinal layers (FIG. 4 (b) compared to insufficient signal strength FIG. 4 (a). This subjective measure reflects both signal strength and contrast.

Segmentation Plausibility Complete and reliable segmentation data is key to successfully determining retinal layer thickness changes or performing shape analysis of the retinal surface. Segmentation algorithms might fail to find the proper retinal border due to low image quality, leading to implausible trajectories, see FIG. 5. Movement artifacts may cause gradient jumps and inconsistencies on the segmentation surface across the B-scans.

We defined segmentation plausibility as no segmentation lines being outside the FOV of the device nor outside the upper or lower image borders in each single A-scan. Furthermore, along B-scans segmentation lines must follow a continuous trajectory without high gradient jumps (FIG. 5 left showing high jumps due to weak signal strength during segmentation). Across B-scans segmentation lines must follow a continuous trajectory without high gradient jumps nor low frequency ripples (FIG. 5 right showing wavy progression due to movements during OCT scan).

High gradient jumps along and across B-scans were identified by empirically determined thresholds using 25 manually labeled volume, radial and circular scans with segmentation errors. Starting with reshaping the segmentation data to 256×256 pixel to achieve uniformity between Spectralis and Cirrus data, we compute the gradient along the B-scans and a threshold of 15 pixels has proven to detect high jumps. Processing the segmentation data with a Gaussian high-pass filter and thresholding it at 13 pixel has proven to detect high jumps successfully across B-scans.

### 6.1.2 Network Architectures and Recognition of Quality Features

Region Detection Network (Reg-Net) The proposed CNN architecture for region detection is shown in FIG. 6. It consists of a basic contraction path of alternating convolution layers and max pooling operations. It takes a grayscale 200×200 pixel image as the input and provides a three class one-hot encoded array. Starting with the encoding path from Cent-Net, multiple training iterations were used to trim down kernel size, number of channels and depth of the network. From the resulting models we chose the model with the highest classification accuracy and a minimum on computational cost.

Three convolution layers, starting with c=8, where c is doubled after the first layer and filter sizes of 7×7 are used in total. Each convolution layer is followed by an activation with a rectified linear unit function (ReLU). The max pooling layers filter the highest activation and reduce the number of parameters, thus saving computation costs. A dense layer to achieve the 3-class-prediction using a softmax function is the last step after flattening the feature map of the last convolutional layer. The output is a probability distribution over the output classes. To regularize the training process and prevent over-fitting, dropout layers were placed after each convolutional layer before the max pooling operation with a dropout rate of r=0.5. The complete model contains just 24 051 parameters and is therefore computational undemanding.

Centering Network (Cent-Net) In case region is ONH, its center position on the SLO image is determined in two steps: A semantic segmentation of the visible optic disc on the SLO image followed by calculating the geometric center of gravity.

To achieve semantic segmentation of the visible optic disc, we designed a fully convolutional neural network similar to the work of Long et al. [2015]. Noh et al. [2015]. Badrinarayanan et al. [2017]. It consists of a contracting (encoding) path of alternating convolution layer. ReLU activation and max pooling operations and an expanding, up-sample path. FIG. 7 shows the architecture of the centering network (Cent-Net). Repetitive training cycles were used to find an optimal receptive field size with a high dice coefficient and accuracy, while keeping kernel size, numbers of channels and depth of the network as small as possible. Saving computational cost while yielding a high performance, the chosen model is suitable to be deployed on average hardware (see FIG. 8). The reader is referred to the supplemental materials to learn more about the iterative process of tuning the model.

The first layer starts with c=8 and increases to c=32 for the point-wise convolution layer in the bottleneck. The filter size of 11×11 was carefully chosen after extensive testing to ensure the model uses the dominant features and neglecting small ones while achieving an optimal receptive field size. Instead of a dense classification layer, a layer with point wise convolutions (filter size of 1×1) follows. This leads to a dense-like layer across the feature channels, but restores the spatial coordinates of the input. Two consecutive convolution transpose layers fine tune and up-sample the feature maps to its original size. The result is a dense pixel-by-pixel prediction, whereby each pixel of the input image is classified using a softmax activation into class ONH or class background (FIG. 8 middle). To regularize the training process and prevent over-fitting, dropout layers were placed before each max pooling operation with a dropout rate of r=0.3. The complete model contains just 176 776 parameters and is therefore able to run on average hardware without special GPU acceleration or memory demands.

The ONH is then identified as the brightest and largest connected component on the prediction map. After binarization of the prediction map, the center position is determined as the geometric center of gravity as shown in FIG. 8 (right).

In the case region is macula, since macular structures do not have unique visibility on SLO images like the ONH, segmentation data of the inner limiting membrane (ILM) and the Bruch's membrane (BM) is used to determine the thinnest point between ILM and BM as foveal pit.

This process might be prone to errors due to insufficient number of adjacent B-scans, a complete absence of the macula in the images or pathological abnormalities, where the macula looses its distinctive shape. To ensure a true foveal pit at the localized point, a surface inspection of the ILM is performed. On 35 macula volume scans, experimentally determined thresholds were used to evaluate both the compression parameters and the RMSE. A successful fovea fit yields compression parameters of >0.002 for the A-scan axis and >0.35 for the B-scan axis and a root mean square error (RMSE) of ≤10 pixel of the paraboloid surface and the ILM. A Matthews correlation coefficient (MCC) of 0.898 together with a sensitivity of 1.00 and a specificity of 0.83 indicate a high rate of correct classification.

Completeness Check and Signal Strength Network (AQUA-Net) The assessment of image quality is performed by classifying the B-scan content A-Scan-wise into four classes regarding signal sufficiency and image completeness. For this, we designed our automatic-quality-analysis-net (AQUA-Net), a deep CNN (DCNN) classifier, consisting of five consecutive residual blocks followed by four additional convolution layers providing a A-Scan-wise quality prediction. The input is a 496×512 pixel gray scale B-Scan image and the output is 512×4 classes one-hot-encoded array yielding quality prediction for each A-Scan. Filter size, number of channels per layer, and network depth were carefully altered through repetitive training cycles to obtain an optimized network behavior regarding prediction accuracy and computing performance.

Two consecutive convolution layers with 3×3 filter size, a residual connection that skips the second layer and concatenates before the following max pooling operation form one residual block. The first block contains c=8 channels per layer and c gets doubled for each subsequent residual block until c=32. The residual connections provide earlier output to later layers, thus creating shortcuts within the network and help battle the vanishing gradients problem in training deep networks. The max pooling operations perform just on the vertical image axis in order to preserve the spatial coordinates in the horizontal axis of the image. The final prediction is obtained by the last two point-wise convolutional layers that act like channel-wise dense layers with a final softmax activation. To regularize the training process and prevent over-fitting, dropout layers were placed before each max pooling operation with a dropout rate of r=0.3. The model contains just 109 308 parameters and is therefore able to run on average hardware.

Surface Segmentation Plausibility Surface segmentation plausibility is detected using traditional image analysis methods. To assess the quality and plausibility the gradients of the segmentation along and across the B-scans are calculated. Assuming that segmentation should be continuous, discontinuities and significantly high gradient jumps indicate segmentation start and end points as well as segmentation errors. The non-uniform region of the ONH can be excluded from the analysis to avoid false results. FIG. 5 left shows an example for a partially failed ILM segmentation.

To check the plausibility, the system analyses the segmentation data for areas that do not correspond to the actual course of the retina. This includes the recognition of areas in which the segmentation runs along the upper or lower image edges of the B-scan. This is especially true for regions where the segmentation follows the course of the retina clipping image borders.

In multiple applications in neurology it is important to obtain a clear three dimensional segmentation of the retinal layers [Yadav et al., 2018]. A failed or missing B-scan registration leads to inconsistent and highly erroneous segmentation across the B-scans despite an accurate segmentation of the B-scan itself. These errors are manifested by fluctuations of the segmentation across the B-scans, which may also be periodic (FIG. 5. right).

### 6.1.3 Loss Functions

For end-to-end training of Reg-Net, Cent-Net, and AQUA-Net we applied two different loss functions (Table 3). Categorical cross entropy (CCE) is used for training of Reg-Net and AQUA-Net and defined as:

$${Loss}_{C C E} = - {\sum }_{i}^{C} {t}_{i} log ( f ( {s}_{i} ) ) , \qquad ( 1 )$$

where t, and f (s;) are the ground-truth and the predicted score after softmax activation for each class, respectively.

For training of Cent-Net we used a combination of CCE and Tversky loss. Tversky loss [Salehi et al., 2017] addresses highly imbalanced data, which is beneficial specifically for Cent-Net where the ONH makes up just a small proportion of the SLO image with the remaining being the background.

$${Loss}_{T v e r s k y} = 1 - \frac{T P}{T P + α F N + β F P} , \qquad ( 2 )$$

where TP stands for true positives, FN is false negatives, and FP is false positives, respectively. With the two parameters α and β, where a +3-1. FN can be penalised more for the value set to a >3. According to Salehi et al. [2017], the output has the optimum balance regarding sensitivity and specificity with α=0.7 and β=0.3. Same values were also applied in our training process. The Cent-Net loss function was then described as:

$${Loss}_{Combined} = {Loss}_{CCE} + {Loss}_{T v e r s k y} , \qquad ( 3 )$$

### 6.1.4 Experiment

Data Training and validation data was derived from the institute's OCT database containing approx. 45 000 scans of adult subjects at the time of data query (2017). The data was fully anonymous, not allowing summary statistics regarding age and sex and underlying conditions. The data was derived from healthy controls and patients with neurologic disorders, the majority of which with autoimmune neuroinflammatory diseases, i.e. multiple sclerosis. Notably, while the data contains incidental retinal or primary eye disorders, it is not an ophthalmology derived data set containing only limited numbers of scans with primary eye disorders. Data have been obtained over 15+years of measurements using multiple device and control software iterations. For this project We selected OCT scans that were obtained with Spectralis spectral-domain OCT (Heidelberg Engineering, Heidelberg, Germany) and Cirrus HD-OCT (Carl Zeiss Meditec, Dublin, California). To get a OCT device-independent and robust model performance, a high variability in the training data set is crucial, e.g. image noise, artifacts, pathological abnormalities and region. To achieve a diverse B-scan dataset representing different clinical modalities we selected the following B-scan listed in table 2.

TABLE 2
The table shows the summary of the B-scan specifications used in our dataset.

| Device | Region | Scan type | B-scans | A-scans per B-scan | Coverage | Number of scans |
|---|---|---|---|---|---|---|
| Spectralis | Macular | Volume | 61 | 768 | 25° × 30° | 413 |
| Spectralis | Macular | Volume | 25 | 1024 | 25° × 30° | 43 |
| Spectralis | Macular | Volume | 19 | 1536 | 25° × 30° | 46 |
| Spectralis | ONH | Volume | 145 | 384 | 15° × 15° | 231 |
| Spectralis | ONH | Volume | 73 | 768 | 15° × 15° | 18 |
| Spectralis | ONH | Radial | 24 | 768 | 15° × 15° | 63 |
| Spectralis | ONH | Circular | 1 | 1536 | 12° | 230 |
| Spectralis | ONH | Radial-Circular | 27 | 768 | 12° | 104 |
| Spectralis | ONH | Line | 1 | 768 | 15° | 20 |
| Cirrus | Macular | Volume | 200 | 200 | 6 × 6 × 2 mm³ | 117 |
| Cirrus | Macular | Volume | 128 | 512 | 6 × 6 × 2 mm³ | 47 |
| Cirrus | ONH | Volume | 200 | 200 | 6 × 6 × 2 mm³ | 336 |

For our SLO image based approaches we selected the following modalities: 436 Spectralis SLO images centered on fovea covering 30°×30° with resolution 768×768 pixel, 69 Spectralis SLO images centered on fovea covering 30°×30° 385 with resolution 1536×1536 pixel, 261 Spectralis SLO images centered on ONH covering 30°×30° with resolution 768×768 pixel and 402 Spectralis SLO images centered on ONH covering 30°×30° with resolution 768×768 pixel. Because Cirrus SLO images were not provided by the device, we computed pseudo-SLO images by averaging each A-scan to generate a 2D-projection.

Common data augmentation as shearing, shifts, rotation, zoom and flipping was applied to all model datasets after splitting them into train, validate and test sets. We utilized augmentation to compensate for device and class imbalance in the data as well as to further increase data variability up to 15-fold it original class size.

Model Training Data Reg-Net: 948 Spectralis SLOs (568 ONH and 380 macula centered) and 224 Cirrus SLOs (124 ONH and 100 macula centered) were randomly selected. In order to correctly recognize retinal SLOs, a third class of 579 corneal OCT scans [Jahromi et al., 2014] was added. This ensures to detect the presence of retinal SLO images, since corneal OCT scans can be obtained with the same device and uploaded into the AQUA-OCT pipeline.

All images were manually labeled by an experienced expert and the resulting data set of 1751 images was split randomly into a training set of 1050 images and a validation set of 351 images to monitor the training progress. The remaining 350 images were used as a test set to evaluate the final CNN Model after hyperparameter optimisation.

Cent-Net: For supervised training of Cent-Net we reused the data from Reg-Net training of 948 Spectralis SLOs and added 148 randomly selected Cirrus SLOs to the 224 Cirrus SLOs to ensure high variability in shape and size of the optic disc. The optic disc in all images was manually labeled by an experienced expert and the resulting data set of 1320 images was split randomly into a training set of 792, a validation set of 264 and the remaining 264 images were used as a test set to evaluate the final network.

AQUA-Net: The high complexity and huge variability of retinal OCT scans requires a sufficiently large and representative labeled database. 25 752 Spectralis B-scans were randomly selected across all mentioned modalities. All B-scans were labeled A-scan wise with a labeling system specifically designed previously for Spectralis data. The labeling result of this automatic system might be prone to errors, but its accuracy of 95.0% is sufficient enough to rely on the high generalization power of the network. The reader is referred to the supplemental materials to learn more about our automatic labeling system. The data set was then stripped of all B-scans containing exclusively good quality A-scans to reduce class imbalance. All B-scans in the remaining dataset contained A-scans with sufficient quality, 22090 B-scans with low signal strength A-scans, 703 B-scans with upper border incompleteness A-scans and 263 B-scans with lower border incompleteness A-scans. The data set was split into 12711 images for training. 4228 images for monitoring the training progression and the remaining 5151 were used as a test set.

Transfer Learning and Fine Tuning of AQUA-Net: After successful training on data from Spectralis devices, transfer learning on data from Cirrus devices was applied to the model to ensure inter-device usability. Here, the final four convolutional layers were further trained with a low learning rate, while the remaining network stayed frozen in their previous trained state. This ensures adaptation of the higher representations of the network only and keeps the residual convolutional base. A final fine tuning with combined data from Spectralis and Cirrus together was performed to ensure highest performance of the model to Spectralis and Cirrus images equally. Fine tuning was performed with a fairly small learning rate on the complete unfrozen model to allow small changes to update the parameters and adapt to the combined data. Transfer learning was performed on 6223 Cirrus B-scans manually labeled by an expert grader. All B-scans in the data set contained A-scans with sufficient quality, 4682 B-scans with low signal strength A-scans, 2518 B-scans with upper border incompleteness A-scans and 24 B-scans with lower border incompleteness A-scans. 3734 scans were used for training, another 1246 Cirrus B-scans where used to monitor the training process as well as 1243 Cirrus B-scans were finally used to test the post-training performance.

Fine tuning was done using 3091 randomly selected B-scans from the Spectralis training and the Cirrus transfer learning data set in equal shares, carefully hand-labeled by an expert grader. All B-scans in the dataset contained A-scans with sufficient quality, 2749 B-scans with low signal strength A-scans, 1022 B-scans with upper border incompleteness A-scans and 193 B-scans with lower border incompleteness A-scans. We split the data into a training set of 1845 B-scans, a validation set of 632 B-scans and a test of 614 B-scans.

AQUA-OCT Pipeline Validation Data Centering: 100 Spectralis volume scans centered on the fovea were randomly selected for macular centering. Macular center was marked by locating the B-scan and its corresponding A-scan with the fovea centralis. 20 Spectralis and Cirrus volume scans centered on the ONH were randomly selected for ONH centering. ONH center was determined by marking the Bruch's membrane opening in the B-scans and computing the geometric center of gravity and convert this location to SLO coordinates. All labeling was performed by an experienced grader.

Computation Time: To show the timing behavior for a clinical setting, we selected those OCT scan types that are commonly used in our reading center, which are volume scans with 61 and 145 B-scans, radial scan with 24 B-scans and single B-scan circular scans.

Quality Check: To validate the overall quality grading performance of the full pipeline in a clinical setting we randomly selected 100 Spectralis OCT scans of type volume, radial and circular. An experienced grader rated this dataset according to the OSCAR-IB criteria in Tewarie et al. into accepted and failed quality to form the gold standard.

Implementation AQUA-OCT was fully developed in Python and all models were trained using Keras with Tensor-flow back end. The early stopping callback was utilized for all training runs to stop the process after a model reaches convergence while monitoring the validation data accuracy. Training was performed on a Linux server with Intel Xeon E5-2650 CPUs and a NVIDIA GTX1080Ti GPU. All validation and test results were computed on a Windows 10 system with an i7-5600 CPU and a NVidia Geforce 940M GPU (1 GB memory), that exemplarily stands for consumer grade hardware.

TABLE 3
The table shows the summary of the proposed network architectures and their training related information.

| Net. | Input | NL | NC | FS | OC | NP | LF | Opt. | LR | DV | DT |
|---|---|---|---|---|---|---|---|---|---|---|---|
| Reg-Net | slo | 5 | 8 | 7 × 7 | 3 | 24K | CCE | ADAM | 6 × 10⁻⁴ | 1751 | S + C |
| Cent-Net | slo | 8 | 8 | 11 × 11 | 2 | 176K | Combined | ADAM | 9 × 10⁻⁴ | 1320 | S + C |
| AQUA-Net | B-scans | 14 | 8 | 3 × 3 | 4 | 109K | CCE | ADAM | 10⁻³, 6 × 10⁻⁴ | 13153, 4002 | S, C |

Abbreviations: Net—Network, NL—Number of layers, NC—Number of channels, FS: Filter size, OC: Ouput classes, NP: Number of parameters, LF: Loss function, Opt.: Optimizer, LR: Learning rate, DV: Data volume (number of input samples: B-scans or SLO), DT: Data type (device), S: Spectralis, C: Cirrus.

Statistical Method Validation The mean absolute error (MAE), standard deviation, accuracy (acc) and sensitivity (sens) as well as specificity (spec) were computed using Python. We computed the Dice Similarity Coefficient according to Guindon and Zhang:

$$D S C = \frac{2 T P}{2 T P + F P + F N} , \qquad ( 4 )$$

Cohen's Kappa according to McHugh:

$$κ = \frac{P r ( a ) - P r ( e )}{1 - P r ( e )} , \qquad ( 5 )$$

$$\begin{matrix}Pr ( a ) = \frac{T P + T N}{n} , \\ Pr ( e ) = \frac{1}{n} \cdot ( ( \frac{( T P + FN ) \cdot ( T P + F P )}{n} ) + ( \frac{( F P + TN ) \cdot ( F N + T N )}{n} ) ) ,\end{matrix}$$

and Matthews Correlation Coefficient (MCC) according to Chicco and Jurman:

$$M C C - \frac{TP \cdot TN - FP \cdot FN}{\sqrt{( TP + FP ) \cdot ( TP + FN ) \cdot ( TN + FP ) \cdot ( T N + F N )}} , \qquad ( 6 )$$

using Python. Here, TP denotes the true positives, TN the true negatives, FP the false positives, FN the false negatives, n the number of samples, Pr (a) the actual observed agreement and Pr (e) the chance agreement.

### 6.1.5 Results

Model Training Analysis In this section, we show the training performance of all three network models of the AQUA-OCT pipeline. The validation results show the model condition after early stopping. Test data results demonstrate the performance of the model on unseen new data.

Reg-Net: Training convergence was reached after 19 epochs with a validation accuracy of accvat-1.0 on 918 SLO images. Final performance was determined on 916 test SLO images. As it can be seen in table 4, the model reached a stable performance on validation and test data with an accuracy of accₜₑₛₜ=1.0 and a sensitivity and specificity of sens_{Test}=spec_{Test}=1.0. The average prediction time on CPU for a single SLO image is 9 μs. Using the test-GPU computation accelerated to 2.3 μs.

Cent-Net: Training convergence was reached after 37 epochs with a validation accuracy of accvat-0.9939 on 1607 SLO images. Final performance was determined on 1612 test SLO images. Table 4 depicts the model performance on validation and test data with an accuracy of accrest=0.9941 and a dice coefficient of diceTest=0.9462. Dice coefficient was used as metric to choose the best network of all training iterations due to its known capabilities to handle highly imbalanced data in semantic segmentation. In our case SLO images contain a small optic disc compared to a huge background. The average prediction time on CPU for a single SLO image is 75 μs. Running inference on our test-GPU accelerated the computation to 12.5 μs.

AQUA-Net: Training convergence was met after 72 epochs of fine tuning training with a validation accuracy of acc_{Vat}=0.9746 on 1825 B-scans. Final performance was determined on 1912 test B-scans. Table 4 shows the performance on validation and test data set with a final test accuracy of acc_{Test}=0.9688. A sensitivity of sens=0.9632 and a specificity of spec=0.9878 highlight the high classification ability. The receiver operating characteristic (ROC) analysis in FIG. 11 together with its corresponding normalized confusion matrix illustrate the classification ability for each class separately even further. The average prediction time on CPU for a single B-scan is 0.202 s. Running inference on our test-GPU accelerated the computation to 59 μs.

TABLE 4
The table shows the summary of the proposed networks performance on validation
and test data. Metrics are accuracy (acc.), sensitivity (sens.), specificity
(spec.), dice coefficient and prediction time for single a input on CPU.

| | Val. | Val | Val. | Val. | Test | Test | Test | Test | Prediction |
|---|---|---|---|---|---|---|---|---|---|
| Net. | acc. | sens. | spec. | dice | acc. | sens | spec | dice | time [s] |
| Reg-Net | 1.0 | 1.0 | 1.0 | n/a | 1.0 | 1.0 | 1.0 | n/a | 0.009 |
| Cent-Net | 0.9939 | 0.9160 | 0.9971 | 0.9438 | 0.9941 | 0.9165 | 0.9972 | 0.9462 | 0.075 |
| AQUA-Net | 0.9746 | 0.9745 | 0.9916 | n/a | 0.9688 | 0.9632 | 0.9878 | n/a | 0.202 |

Not applicable metrics are marked with n/a.

AQUA-OCT Pipeline Validation Center Detection Table 5 first row shows an error of MAE=(0.0646+0.0571) mm for macular scans, with an average deviation of 0.36 B-scans and 2.45 A-scans to identify the correct B-scan and A-scan of the fovea centralis. The distance between neighbouring B-scans in this data set was 0.1235 mm and for neighbouring A-scans 0.0116 mm. Taken into account the fovea centralis mostly stretches across several A-scans the discrepancy between grader and AQUA-OCT lays within expected tolerances. With less than one B-scan mistaken the precision is limited by the number of B-scans and its pixel scaling. Cirrus macular scans are not included due to the lack of segmentation data in the img-file format.

The second and third row show an error of (0.1107+0.0516) mm for Spectralis and (0.0473+0.0236) mm for Cirrus ONH scans to gold standard ONH center (Table 5). That is equivalent to an average error of 2.45 pixel for

TABLE 5
The table shows the result of the optic nerve head and
macula centering validation as mean absolute error (MAE)
to gold standard and standard deviation in mm.

| OCT device | Region | MAE [mm] | standard deviation [mm] |
|---|---|---|---|
| Spectralis | Macula | 0.0646 | 0.0571 |
| Spectralis | ONH | 0.1107 | 0.0516 |
| Cirrus | ONH | 0.0473 | 0.0236 |

Spectralis and 1.57 pixel for Cirrus images on the Cent-Net 200×200 pixel input images. With an average diameter of (1.8-1.9) mm [Quigley et al., 1990] for the optic disc, meaning about 40 pixel on Spectralis and about 60 pixel on Cirrus Cent-Net input images, this deviation becomes vanishing small for placing the ROI.

Pipeline Computation Time The values in table 6 are averaged over multiple scans. Processing times are linearly dependent on the number of B-scans starting from 0.79 s for a single B-scan OCT file up to 58.44 s for a full volume with 145 B-scans on CPU. GPU support accelerates the matrix computations to run a model immensely, but due to memory and GPU launch overhead its advantage will first come into play at a certain batch size of B-scans.

TABLE 6
The table shows the time behavior of the AQUA-OCT pipeline for
different Spectralis OCT scan types on CPU (i7-5600) and GPU
(GeForce 940M). The complete timed process includes data import,
data review and analysis as well as quality map creation.

| | Volume | Volume | Radial | Circular |
|---|---|---|---|---|
| | 61 B-scans | 145 B-scans | 24 B-scans | 1 B-scan |
| CPU | 28.15 s | 58.44 s | 13.55 s | 0.79 s |
| GPU | 19.15 s | 30.34 s | 15.42 s | 7.6 s |

Quality Check Performance In this section, we demonstrate the overall quality classification performance of the entire pipeline.

Table 7 shows the resulting accuracy, sensitivity and specificity as well as the Matthews correlation coefficient of our results compared to the gold standard. We achieved an AQUA-OCT-rater discrepancy of 3% compared to 10% in the original OSCAR-IB study by Tewarie et al., The AQUA-OCT-rater agreement measured by Cohen's kappa [McHugh, 2012] with a value of K=0.926 can compete with the OSCAR-IB valdiation by Schippling et al. with an inter-rater agreement of K=0.7.

TABLE 7
The table shows metrics of the AQUA-OCT pipeline validation
on 100 randomly chosen OCT scans of various types
(radical scan, circular scan, volume scan).

| Scan Type | Test acc. | Test sens. | Test spec | Test MCC |
|---|---|---|---|---|
| General | 0.9700 | 0.9722 | 0.9643 | 0.927 |
| Circular | 0.9936 | 0.9744 | 0.9375 | 0.912 |
| Volume | 1.00 | 1.00 | 1.00 | 1.00 |
| Radial | 0.9286 | 0.9231 | 1.00 | 0.679 |

Abbreviations: acc.: Accuracy, sens.: Sensitivity, spec.: Specificity, MCC: Matthews correlation coefficient.

The general accuracy of acc_{Test}=0.97 and high specificity of spec_{Test}=0.9643 achieved with our system shows the high capability to correctly rate image quality and discard failed scans. The grader's decision differs in the case of two circular and one radial scan to decisions made by our system. All three scans were somewhat on the fine line between being an accepted and being a failed scan, what was pointed out by the grader.

Output A comprehensive quality output is available after the analysis that contains: First, summary of used analysis configuration as specified in the configuration file, and second, results of the analysis, including the result of the detected region, the centering check, the center position and the deviation from the center of the scanned area, as well as the scan type, the dimensions of the scan and the date of the quality analysis. The results of the individual quality features for all ROI segments are presented in detail. Each feature is classified as passed or failed according to its threshold defined in the configuration. Third, quality maps-A-scan-wise color-coded maps superimposed on the respective SLO fundus image, see FIG. 12—provide fast visual feedback on the overall quality of the scan. The image quality and the segmentation plausibility maps are derived directly from the local feature results.

### 6.2 Image Quality Control

In addition to image quality analysis we define three quality control features to compensate for image artifacts and scan errors to avoid any infidelity in OCT data analysis. This ensures a lower rejection rate for low quality OCT scans and thus, increases the usability of clinical data set while keeping a certain level of quality.

### 6.2.1 Low Quality B-scans Interpolation

Problem Quality problems of single or few B-scans are regularly caused e.g. by saccades. They can lead to whole scans being discarded, despite the vast majority of the scan being of sufficient quality. Approach Low quality areas in B-scans are interpolated, if the surrounding B-scans are of sufficient quality.

Implementation The following steps describe the implementation seen in FIG. 16:
1. Scan of ROI region for the presence of our quality markers low signal strength and incompleteness.
2. Exclude low signal strength marker laying inside the optic disc.
3. Determine the neighboring B-scans of the low quality B-sans.
4. Compute the arithmetic mean of the neighboring B-scans according to equation 7 and substitute the original B-scan in the OCT volume.

The arithmetic mean of the gray values of the two neighboring B-scan pixels are computed with:

$${\overline{p}}_{ij}^{n} = \frac{1}{2} ( {p}_{ij}^{n - 1} + {p}_{ij}^{n + 1} ) , \qquad ( 7 )$$

where p and p are the mean pixel value and pixel gray values respectively. The indices i and j denote the row and column of the pixels in the B-scans and n the number of the B-scan in the OCT volume.

FIG. 13 shows two examples of the successful application of our interpolation method to enhance the quality of OCT volume scans above the minimum threshold. The B-scan in image (a) shows a low signal spreading over nearly half of the B-scan. This signal loss prevents a reliable retinal layer segmentation. Image (b) demonstrates the interpolated B-scan at that same position in the OCT volume, showing clear outer boundaries and retinal layers. Image (c) shows an example B-scan with an incomplete retinal image. The retina is clipping outside the upper image edge resulting in an, e.g. incorrect segmentation of the inner limiting membrane (ILM) and subsequently an inaccurate shape analysis. Image (d) demonstrates the interpolated B-scans at that same position in the OCT volume with a restored and complete ILM. In both cases, this method was able to increase the quality sufficiently to ensure the usability of the OCT scans.

### 6.2.2 Adaptive ROI in Macular Volume Scans

Problem The distance between the fovea center and optic disk is variable in nature and dependent e.g. on eye shape and ethnicity. Therefore, using fixed size regions of interest for disease monitoring could lead to inaccurate measurement caused by overlapping regions. Further, algorithms to segment the outer boundaries as well as the inner retinal layers are carefully designed and/or trained for their specific retinal region. A segmentation algorithm designed for macular layer segmentation might create inaccurate or even unpredictable segmentation results for the region of the ONH, thus, leading to incorrect layer thickness results.

Approach The ROI will be down-sized if it is too close or overlapping the area of the optic disc. The maximum allowable distance between ROI and optic disc contour is defined by a safety margin.

Implementation To correct a ROI overlapping the optic disc the following steps seen in FIG. 17 are implemented:
1. Perform the semantic segmentation of the optic disc on SLO images based on the Cent-Net model in AQUA-OCT.
2. Determine the contour of the optic disc from the optic disc segmentation as red markings in FIG. 14.
3. Check whether ROI and optic disc are overlapping or in too close proximity to each other, defined by a safety pixel margin.
4. Compute the maximum allowed ROI radius Tₘᵢₙ between the fovea centralis and the optic disc contour with regard to the safety pixel margin according to equation 8.
5. Set the outer radius of the ROI to the new computed maximum allowed radius rₘᵢₙ.

The closest distance between fovea centralis and optic disc contour is defined by the smallest euclidean distance:

$${r}_{min} = min ( \sqrt{{( {x}^{f c} - {x}_{i}^{o d} )}^{2} + {( {y}^{f c} - {y}_{i}^{o d} )}^{2}} ) - {p}_{s m} , \qquad ( 8 )$$

where rₘᵢₙ is the smallest distance between fovea centralis and optic disc contour, r^{fc} and y^{fc} the x and y coordinates of the fovea centralis on the scanning laser ophthalmoscope (SLO) fundus image and rod and y^{od} the x and y SLO coordinates of the optic disc contour with i the index of the contour point. The term Pₛₘ represents the safety margin, which is used as an offset between the contour of the optic disk and the adaptive ROI.

FIG. 14 shows the effect of reducing the ROI size to prevent the optic disc being inside the ROI for macular layer segmentation. This method provides the necessary controlling to prevent probable segmentation errors and thus, ensures the usability of the OCT data.

### 6.2.3 Retinal Region Re-Centering

Problem There are two main regions used in retinal OCT, the optic nerve head (ONH) and the macula. Usually to evaluate such OCT scans, regions-of-interest (ROI) are placed over the target region by the device operator to analyze the data equidistant around the region center. A misplaced ROI not centered on the ONH or macula will miss important data to analyze and lead to quality failures. Time pressure, working hours as well as personal well-being might influence an operators ability to correctly identify and mark the aforementioned areas. This highlights the need to not only examine the accuracy of the operator's center placement but to provide an operator-independent ROI-placement for further data analysis usage.

Approach The center of the ONH and the macula are determined using SLO images and B-scans and substitute the incorrect values in the OCT data for further image analysis. The center of the ONH is defined as the geometric center of gravity of the Bruch's membrane opening (BMO) [Yadav et al., 2018]. On the other hand, the center of the macula is defined as the fovea centralis, the deepest point within the foveal pit, containing a bright light reflex [Yadav et al., 2017].

Implementation The following steps describe the implementation as seen in FIG. 18:
1. Classify the input OCT scan as either ONH or macula scan using the SLO-based Reg-Net in AQUA-OCT.
2. For ONH:
   (a) Perform the semantic segmentation of the optic disc on SLO images based on the Cent-Net model in AQUA-OCT. The output is a binary map showing the area of the optic disc and background.
   (b) Compute the center of the segmentation as the center of mass using equation 9 of the optic disc.
3. For macula:
   (a) Get segmentation data of outer boundaries ILM and BM.
   (b) Subtract BM height values from ILM data to compensate for highly angled B-scans.
   (c) Compute the macula center using grid search of compensated ILM data for deepest pit within a safety margin to the volume borders.
   (d) Fit a paraboloid on the macula center using least squares method and evaluate its parameters to ensure the deepest pit as fovea centralis.

The center of mass is computed using:

$$\begin{matrix}{x}_{c o m} = \frac{1}{M} {\sum }_{i = 1}^{n} {m}_{i} {x}_{i} , \\ {y}_{com} = \frac{1}{M} {\sum }_{i = 1}^{n} {m}_{i} {y}_{i} , \\ M = {\sum }_{i = 1}^{n} {m}_{i} ,\end{matrix} \qquad ( 9 )$$

where I′com and ycom are the x- and y-coordinates of the center of mass, r; and y, the x- and y-coordinates at position i, M the total pixel value and mi the pixel value of pixel i.

The coordinates are saved within the quality report to be used in further data processing steps that needs to be performed equidistant around the center, e.g. retinal layer segmentation, peripapillary circular scan extraction as well as surface shape analysis [Yadav et al., 2017]. FIG. 15 shows an example of (a) a misplaced ROI that misses the data around the optic disc and (b) the re-centered ROI catching the data equidistant from the optic disc center.

### 7 CITATION LIST

### References

A. Aytulun. A. Cruz-Herranz, O. Aktas, L. J. Balcer. L. Balk. P. Barboni. A. A. Blanco. P. A. Calabresi. F. Costello, B. Sanchez-Dalmau, D. C. DeBuc. N. Feltgen. R. P. Finger, J. L. Frederiksen, E. Frohman, T. Frohman, D. Garway-Heath. I. Gabilondo. J. S. Graves, A. J. Green. H. P. Hartung. J. Havla, F. G. Holz. J. Imitola, R. Kenney. A. Klistorner, B. Knier, T. Korn, S. Kolbe, J. Krmer, W. A. Lagrze, L. Leocani, O. Maier, E. H. Martnez-Lapiscina, S. Meuth, O. Outteryck, F. Paul, A. Petzold. G. Pihl-Jensen. J. L. Preiningerova, G. Rebolleda, M. Ringelstein, S. Saidha, S. Schippling, J. S. Schuman, R. C. Sergott, A. Toosy, P. Villoslada. S. Wolf, E. A. Yeh, P. Yu-Wai-Man, H. G. Zimmermann, A. U. Brandt, and P. Albrecht. The apostel 2.0 recommendations for reporting quantitative optical coherence tomography studies. Neurology. 2021. ISSN 0028-3878. doi: 10.1212/wnl.0000000000012125. URL https://n.neurology.org/content/neurology/early/2021/04/28/WNL. 0000000000012125.full. pdf.
V. Badrinarayanan, A. Kendall, and R. Cipolla. SegNet: A Deep Convolutional Encoder-Decoder Architecture for Image Segmentation. IEEE Transactions on Pattern Analysis and Machine Intelligence, 39 (12): 2481-2495 December 2017. ISSN 0162-8828.
L. J. Balk. W. A. de Vries-Knoppert, and A. Petzold. A simple sign for recognizing off-axis oct measurement beam placement in the context of multicentre studies. PLOS One, 7 (11): e48222. 2012. ISSN 1932-6203 (Electronic) 1932-6203 (Linking). doi: 10.1371/journal.pone.0048222. URL https://www.ncbi.nlm.nih.gov/pubmed/23144857https://www.ncbi.nlm.nih.gov/pmc/articles/PMC3493550/pdf/pone.0048222.pdf.
L. J. Balk, A. Cruz-Herranz, P. Albrecht, S. Arnow, J. M. Gelfand, P. Tewarie, J. Killestein, B. M. Uitde-haag. A. Petzold, and A. J. Green. Timing of retinal neuronal and axonal loss in ms: a longitudinal oct study. J Neurol. 263 (7): 1323-31, 2016. ISSN 1432-1459 (Electronic) 0340-5354 (Linking). doi: 10.1007/s00415-016-8127-y. URL https://www.ncbi.nlm.nih.gov/pubmed/27142714https://www.ncbi.nlm.nih. gov/pmc/articles/PMC4929170/pdf/415_2016_Article_8127.pdf.
Alexander U. Brandt, Elena H. Martinez-Lapiscina, Rachel Nolan, and Shiv Saidha. Monitoring the Course of MS With Optical Coherence Tomography. Current Treatment Options in Neurology. 19 (4): 15. April 2017. ISSN 1534-3138. doi: 10.1007/s11940-017-0452-7. URL https://doi.org/10.1007/s11940-017-0452-7.
D. Cabrera DeBuc, M. Gaca-Wysocka, A. Grzybowski, and P. Kanclerz. Identification of retinal biomarkers in alzheimer's disease using optical coherence tomography: Recent insights, challenges, and opportunities. J Clin Med. 8 (7): 996-996. 2019. ISSN 2077-0383 (Print) 2077-0383 (Linking).
Davide Chicco and Giuseppe Jurman. The advantages of the matthews correlation coefficient (mcc) over fl score and accuracy in binary classification evaluation. BMC genomics, 21 (1): 1-13, 2020.
Jeffrey De Fauw, Joseph R. Ledsam, Bernardino Romera-Paredes, Stanislav Nikolov, Nenad Tomasev, Sam Black-well, Harry Askham, Xavier Glorot, Brendan ODonoghue, Daniel Visentin, George van den Driessche, Balaji Lakshminarayanan, Clemens Meyer, Faith Mackinder, Simon Bouton, Kareem Ayoub, Reena Chopra, Dominic King. Alan Karthikesalingam, Can O. Hughes, Rosalind Raine, Julian Hughes, Dawn A. Sim, Catherine Egan, Adnan Tufail, Hugh Montgomery, Demis Hassabis, Geraint Rees, Trevor Back, Peng T. Khaw, Mustafa Suley-man. Julien Cornebise, Pearse A. Keane, and Olaf Ronneberger. Clinically applicable deep learning for diagnosis and referral in retinal disease. Nature Medicine, pages 1-1, 2018. doi: 10.1038/s41591-018-0107-6. URL http: //www.nature.com/articles/s41591-018-0107-6https://www.nature.com/articles/s41591-018-0107-6.
Bert Guindon and Ying Zhang. Application of the dice coefficient to accuracy assessment of object-based image classification. Canadian Journal of Remote Sensing, 43 (1): 48-61, 2017.
Yijun Huang. Sapna Gangaputra, Kristine E. Lee, Ashwini R. Narkar, Ronald Klein, Barbara E. K. Klein, Stacy M. Meuer, and Ronald P. Danis. Signal Quality Assessment of Retinal Optical Coherence Tomography ImagesOCT Signal Quality Assessment. Investigative Ophthalmology & Visual Science, 53 (4): 2133-2141. April 2012. ISSN 1552-5783.
Mahdi Kazemian Jahromi, Raheleh Kafieh, Hossein Rabbani, Alireza Mehri Dehnavi, Alireza Peyman, Fedra Ha-jizadeh, and Mohammadreza Ommani. An Automatic Algorithm for Segmentation of the Boundaries of Corneal Layers in Optical Coherence Tomography Images using Gaussian Mixture Model. Journal of Medical Signals and Sensors, 4 (3): 171-180, 2014. ISSN 2228-7477.
Josef Kauer, Kay Gawlik, Hanna G. Zimmermann, Ella Maria Kadas, Charlotte Bereuter, Friedemann Paul, Alexander U. Brandt, Frank Hauer, and Ingeborg E. Beckers. Automatic quality evaluation as assessment standard for optical coherence tomography. In Advanced Biomedical and Clinical Diagnostic and Surgical Guidance Systems XVII, volume 10868, page 1086814. International Society for Optics and Photonics, February 2019.
Kyungmoo Lee, Gabrille H. S. Buitendijk, Hrvoje Bogunovic, Henrit Springelkamp, Albert Hofman, Andreas Wahle, Milan Sonka, Johannes R. Vingerling, Caroline C. W. Klaver, and Michael D. Abrmoff. Automated Segmentability Index for Layer Segmentation of Macular SD-OCT Images. Translational Vision Science & Technology, 5 (2): 14-14, Mar. 2016. ISSN 2164-2591.
Shuang Liu, Amit S. Paranjape, Badr Elmaanaoui, Jordan Dewelle. H. Grady Rylander, Mia K. Markey, and Thomas E. Milner. Quality assessment for spectral domain optical coherence tomography (OCT) images. In Multimodal Biomedical Imaging IV. volume 7171, page 71710X. International Society for Optics and Photonics, Feb. 2009.
J. Long, E. Shelhamer, and T. Darrell. Fully convolutional networks for semantic segmentation. In 2015 IEEE Conference on Computer Vision and Pattern Recognition (CVPR), pages 3431-3440 Jun. 2015.
Mary L. McHugh. Interrater reliability: the kappa statistic. Biochemia Medica, 22 (3): 276-282, October 2012. ISSN 657 1330-0962.
Seyedamirhosein Motamedi, Kay Gawlik, Noah Ayadi, Hanna G. Zimmermann, Susanna Asseyer, Charlotte Bereuter, Janine Mikolajczak, Friedemann Paul, Ella Maria Kadas, and Alexander Ulrich Brandt. Normative data and minimally detectable change for inner retinal layer thicknesses using a semi-automated oct image segmentation pipeline. Frontiers in Neurology, 10:1117-1117, 2019.
Seyedamirhosein Motamedi, Frederike C. Oertel, Sunil K. Yadav, Ella M. Kadas, Margit Weise, Joachim Havla, Marius Ringelstein, Orhan Aktas, Philipp Albrecht, Klemens Ruprecht, Judith Bellmann-Strobl, Hanna G. Zimmermann, Friedemann Paul, and Alexander U. Brandt. Altered fovea in aqp4-igg-seropositive neuromyelitis optica spectrum disorders. Neurology (R) neuroimmunology & neuroinflammation, 7 (5): e805 e805, 2020.
H. Noh, S. Hong, and B. Han. Learning deconvolution network for semantic segmentation. In 2015 IEEE International Conference on Computer Vision (ICCV), pages 1520-1528, 2015.
Florence Pache, Hanna Zimmermann, Janine Mikolajczak, Sophie Schumacher, Anna Lacheta, Frederike C. Oertel, Judith Bellmann-Strobl, Sven Jarius, Brigitte Wildemann, Markus Reindl, Amy Waldman, Kerstin Soelberg, Nasrin Asgari, Marius Ringelstein, Orhan Aktas, Nikolai Gross, Mathias Buttmann, Thomas Ach, Klemens Ruprecht. Friedemann Paul, Alexander U. Brandt, and in cooperation with the Neuromyelitis Optica Study Group (NEMOS). MOG-IgG in NMO and related disorders: a multicenter study of 50 patients. Part 4: Afferent visual system damage after optic neuritis in MOG-IgG-seropositive versus AQP4-IgG-seropositive patients. Journal of Neuroinflammation, 13 (1): 282, November 2016. ISSN 1742-2094.
Axel Petzold, Johannes F de Boer, Sven Schippling, Patrik Vermersch, Randy Kardon, Ari Green, Peter A Calabresi, and Chris Polman. Optical coherence tomography in multiple sclerosis: a systematic review and meta-analysis. The Lancet Neurology, 9 (9): 921-932, September 2010. ISSN 1474-4422. doi: 10.1016/S1474-4422 (10) 70168-X. URL http://www.sciencedirect.com/science/article/pii/S147444221070168X.
H. A. Quigley. A. E. Brown. J. D. Morrison, and S. M. Drance. The size and shape of the optic disc in normal human eyes. Archives of Ophthalmology (Chicago, Ill.: 1960), 108 (1): 51-57, January 1990. ISSN 0003-9950.
Seyed Sadegh Mohseni Salehi, Deniz Erdogmus, and Ali Gholipour. Tversky Loss Function for Image Segmentation Using 3D Fully Convolutional Deep Networks. In Qian Wang, Yinghuan Shi, Heung-Il Suk, and Kenji Suzuki, editors, Machine Learning in Medical Imaging, Lecture Notes in Computer Science, pages 379-387, Cham, 2017. Springer International Publishing.
S Schippling, LJ Balk, F Costello, P Albrecht, L Balcer, PA Calabresi, JL Frederiksen, E Frohman, AJ Green, A Klistorner, O Outteryck, F Paul, GT Plant, G Traber, P Vermersch, P Villoslada, S Wolf, and A Petzold. Quality control for retinal OCT in multiple sclerosis: validation of the OSCAR-IB criteria. Multiple Sclerosis Journal, 21 (2): 163-170, February 2015. ISSN 1352-4585.
D. M. Stein, H. Ishikawa, R. Hariprasad, G. Wollstein, R. J. Noecker, J. G. Fujimoto, and J. S. Schuman. A new quality assessment parameter for optical coherence tomography. British Journal of Ophthalmology, 90 (2): 186-190, February 2006. ISSN 0007-1161, 1468-2079.
Prejaas Tewarie, Lisanne Balk, Fiona Costello, Ari Green, Roland Martin, Sven Schippling, and Axel Petzold. The OSCAR-IB Consensus Criteria for Retinal OCT Quality Assessment. PLOS ONE, 693 7 (4): e34823, April 2012. ISSN 1932-6203.
L. Veys, M. Vandenabeele, I. Ortuo-Lizarn, V. Baekelandt, N. Cuenca, L. Moons, and L. De Groef. Retinal alpha-synuclein deposits in parkinson's disease patients and animal models. Acta Neuropathol, 137 (3): 379-395, 2019. ISSN 0001-6322. J. Wang, G. Deng, W. Li, Y. Chen, F. Gao, H. Liu, Y. He, and G. Shi. Deep learning for quality assessment of retinal oct images. Biomed Opt Express, 10 (12): 6057-6072, 2019. ISSN 2156-7085 (Print) 2156-7085.
Rui Wang, Dongyi Fan, Bin Lv, Min Wang, Qienyuan Zhou, Chuanfeng Lv, Guotong Xie, and Lilong Wang. Oct image quality evaluation based on deep and shallow features fusion network. In 2020 IEEE 17th International Symposium on Biomedical Imaging (ISBI), pages 1561-1564 Apr. 2020. ISSN: 1945-8452.
Ziqiang Wu, Jingjing Huang, Laurie Dustin, and Srinivas Sadda. Signal Strength Is an Important Determinant of Accuracy of Nerve Fiber Layer Thickness Measurement by Optical Coherence Tomography. Journal of glaucoma, 18 (3): 213-216, March 2009. ISSN 1057-0829.
Sunil Kumar Yadav, Seyedamirhosein Motamedi, Timm Oberwahrenbrock, Frederike Cosima Oertel, Konrad Polthier, Friedemann Paul, Ella Maria Kadas, and Alexander U. Brandt. CuBe: parametric modeling of 3d foveal shape using cubic bezier. Biomedical Optics Express, 8 (9): 4181 Aug. 2017.
Sunil Kumar Yadav, Ella Maria Kadas, Seyedamirhosein Motamedi, Konrad Polthier, Frank Hauer, Kay Gawlik, Friedemann Paul, and Alexander Brandt. Optic nerve head three-dimensional shape analysis. Journal of Biomedical Optics, 23 (10): 106004, October 2018. ISSN 1083-3668, 1560-2281. Publisher: International Society for Optics and Photonics.
Min Zhang, Jia Yang Wang, Lei Zhang, Jun Feng, and Yi Lv. Deep residual-network-based quality assessment for SD-OCT retinal images: preliminary study. In Medical Imaging 2019: Image Perception, Observer Performance, and Technology Assessment, volume 10952, page 1095214. International Society for Optics and Photonics, March 2019.

1. A method, particularly a computer-implemented method or a computer program that when executed on a computer executes the steps of the method, wherein the method is configured for a quality control of an optical coherence tomography (OCT) retinal image (OCT image).

2. The method according to claim 1 wherein the quality control is performed by an ensemble of trained convolutional neural networks, particularly wherein ensemble is a modular ensemble, wherein the convolutional neural networks are executed on a processor of computer that is in communication with a data memory for storing parameters of the trained convolutional neural networks or wherein the convolutional neural networks are configured to execute the quality control.

3. The method according to claim 1, wherein the method is executed on an OCT measurement device configured to record the OCT image and to execute the method.

4. The method according to claim 1, wherein the method is executed on a server or a server network, that is configured to receive the OCT image, particularly from the measurement device, particularly via a data network connection provided by the internet or a mobile data network, and particularly wherein the quality control is performed as part of a remote computer service over a network.

5. The method according to claim 1, wherein the method automatically rejects or accepts OCT images, and a feedback of a quality metric is provided to a user of the method, particularly wherein the feedback is provided by means of a displayed message or information.

6. The method according to claim 1, wherein the method further comprises the steps of:
a) starting and executing a user application with a default configuration file comprising information on a scan type and OCT image dimensions, quality features, thresholds and regions of interest (ROIs) of the OCT image,
b) providing, particularly uploading the OCT image data to the method, particularly to the user application or the server or server network,
c) reading the retina OCT image data,
d) matching information from the configuration file to the uploaded OCT image, particularly wherein the infor-mation relates to constraints for the OCT image,
e) employing a DCNN for a centering check such that the information about the ROI in configuration file from the center of the landmarks, macula center and/or optic nerve head center is comprised in the OCT image,
f) employing a DCNN for signal strength and completeness of each slice (B-scan) comprised in the OCT image,
g) executing a segmentation plausibility assessment for any segmentation that is differentiating between different regions and/or layers of each B-scan comprised in the OCT image,
h) generating of metrics for each of the steps e)-g),
i) applying the thresholds comprised in the information of the configuration file to the metrics from h) in order to complete the quality assessment and generate
j) a report of the quality assessment results accompanied by visual aids as user feedback particularly in form of color coded maps generated from the quality features overlayed atop of a scanning laser ophthalmoscopy (SLO) image associated to or comprised by the OCT image data, or if the SLO image is unavailable from a projection image generated from the OCT image,
k) generating and providing, e.g. in form of displaying, a detailed quality result spread sheet,
l) wherein the user has the possibility to predefine using a configuration file different analysis procedures, quality features, thresholds and ROIs regarding their data, e.g. circular- or volume-scans.

7. The method according to claim 6, further comprising the steps of:
interpolating single low quality B-scans, if the surrounding B-scans are of sufficient quality wherein:
low quality B-scans comprised in the retina OCT image are automatically detected as defined by the metrics and configuration file, wherein the metrics considered are low signal and incompleteness comprising the steps of:
a) detecting the B-scans inside the ROI the configuration file
b) excluding the low signal strength metric inside the optic disc automatically detected by the computerized system
c) determining the neighboring B-scans of the detected low quality B-scan
d) computing the arithmetic mean of the neighboring B-scans, wherein this computation is performed on the pixel gray level according to the equation:
$${\overline{p}}_{ij}^{n} = \frac{1}{2} ( {p}_{ij}^{n - 1} + {p}_{ij}^{n + 1} ) , \qquad ( 10 )$$
where p and p are the mean pixel value and pixel gray values respectively, The indices i
and j denote the row and column of the pixels in the B-scans and n the number of the B-scan in the OCT volume.

8. The method according to claim 7 where the original low quality B-scan is substituted with the newly arithmetic mean computed B-scan, whereas the final quality metrics and reports are recomputed with the substituted B-scans.

9. The method according to claim 6 further comprising the steps of:
adapting the predefined ROI from the configuration file to the distance between the fovea center and optic disk.

10. The method according to claim 9, in which a ROI is down-sized if it is too close or overlapping the area of the optic disc defined by a safety margin, whereas the safety margin is computed as the smallest euclidean distance according to the equation
$${r}_{min} = min ( \sqrt{{( {x}^{f c} - {x}_{i}^{o d} )}^{2} + {( {y}^{f c} - {y}_{i}^{o d} )}^{2}} ) - {p}_{s m} , \qquad ( 11 )$$
wherein rₘᵢₙ is the smallest distance between fovea centralis and optic disc contour, x and y^{fc} the x and y coordinates of the fovea centralis on the SLO fundus image or generated projection image and xᵢ^{od} and yᵢ^{od} the x and y SLO or generated projection image coordinates of the optic disc contour with i the index of the contour point.

11. The method according to claim 9 where the predefined ROI in the configuration file is automatically exchanged by the adapted ROI, wherein the automated computerized quality assessment system generates the reports using the adaptive ROI.

12. The method according to claim 6 comprising of further automatically re-centering the retina OCT image, where the re-centering coordinates are saved within the quality report, whereas the correct center coordinates can be employed in further OCT retina image analysis.

13. The method according to claim 12, wherein in case the region detected is that of the optic nerve head, the following steps are executed:
a) semantic segmentation of the optic disc using a DCNN approach on the SLO image, b) optic disc segmentation using the center mass according to the equation
b) optic disc segmentation using the center mass according to the equation
$$\begin{matrix}{x}_{c o m} = \frac{1}{M} {\sum }_{i = 1}^{n} {m}_{i} {x}_{i} , \\ {y}_{com} = \frac{1}{M} {\sum }_{i = 1}^{n} {m}_{i} {y}_{i} , \\ M = {\sum }_{i = 1}^{n} {m}_{i} ,\end{matrix} \qquad ( 12 )$$
where xcom and ycom are the x- and y-coordinates of the center of mass, xi and yi the x- and y-coordinates at position i, M the total pixel value and mi the pixel value of pixel i.

14. The method according to claim 1,
where in case the region detected is that of the macula, the following steps are executed:
a) acquisition of the boundary information of two surfaces delimiting the retina, the inner limiting membrane (ILM) and that of the Bruch's membrane (BM)
b) compensation for high angled B-scan by substraction of BM height values from ILM data
c) computation of the macula center using a grid search for the deepest pit, where the search is performed on the computed compensated ILM data from the previous step
d) check to ensure that the deepest point is the center of the fovea centralis, whereas the check to ensure that the deepest point detected is representing the fovea centrals is computed using a paraboloid fit and evaluating the fitting parameters, whereas the paraboloid fit can be performed using a least square method.

15. The method according to claim 6 further comprising the steps of:
a) collecting different retina OCT image datasets over time
b) automated analysis of these datasets with the computerized quality assessment system
c) adapting the thresholds sets in the configuration file for different use cases
d) whereas different use cases may comprise specific diseases in which case adapting the threshold means updating the values in the configuration file according to the disease specific ROIs and image characteristics.

16. A system configured to execute the method according to claim 1, particularly wherein the system comprises at least one computer configured to execute the quality control.
